(19) United States
(12) Patent Application Publication
(10) Pub. No.: US 2004/0034607 A1
(43) Pub. Date: Feb. 19, 2004

(54) Validating communication between participants in an electronic interaction

(76) Inventor: Giacomo Piccinelli, Bristol (GB)

Correspondence Address: HEWLETT-PACKARD COMPANY, Intellectual Property Administration, P.O. Box 272400, Fort Collins, CO, 80527-2400, US

(21) Appl. No.: 10/218,856

(22) Filed: Aug. 13, 2002

(51) Int. Cl. G06F 17/60

(52) U.S. Cl. 705/80

(57) ABSTRACT

From a commercial viewpoint, the Internet is evolving from a collection of web sites for advertising products to an open and distributed environment for service provision. Electronic marketplaces represent the mediation contexts where service providers and service consumers can interact to carry out their business transactions. In electronic business relationships the issue of trust becomes central, and its enforcement is a fundamental value that electronic marketplaces can offer to their members. We focus on trusted contract enforcement in the context of an electronic marketplace infrastructure. In particular, it describes the model and the component for mediated service delivery developed by the applicant. The presented solution is based on the concept of externalisation for service consumer views of the business processes of service providers.

### FIELD OF THE INVENTION

This invention relates to a method of combining computer process management and authorisation systems and apparatus therefor.

### BACKGROUND OF THE INVENTION

The Internet offers a global and ubiquitous platform to support the deployment and provision of electronic services (e-services). Electronic marketplaces (e-marketplaces) and e-services are among the main drivers of the Internet evolution, from both a business and a technology perspective.

E-services are about business assets made available over the Internet to drive new revenue streams and to create new efficiencies. E-marketplaces are the virtual context where to find the match between the customers' demand for services with the set of service offers. The process of negotiation between service consumer and service provider produces a contract that captures and formalises the agreement between the parties. The contract embeds the rules for the interaction between service consumer and service provider. As it happens in normal business contexts, service delivery follows contract acceptance by both parties.

Negotiation and contract formation tend to follow standard patterns, largely independent of traded services. The automation of the negotiation process is therefore relatively easy, when compared to service delivery and contract enforcement. It is not uncommon for existing e-marketplaces to support negotiation and contract formation, while contract enforcement is usually beyond their scope and technical capabilities. Second-generation e-marketplaces will progressively take on the role of trusted mediators, to validate the actions of the parties against the agreed contract (see for example Casati F., Ilnicki S., Jin L., Shan M. C., “An Open, Flexible, and Configurable System for Service Composition” Workshop on Advanced Issues of E-Commerce and Web-Based Information Systems (WECWIS 2000), IEEE Computer Society, San Jose, USA (2000), Gipson M., Runett R., Wood L., and Clawson P., “The Electronic Marketplace 2003: Strategies For Connecting Buyers And Sellers” Simba Information Inc. (1999), HP, Hewlett-Packard E-service initiative. http://e-services.hpp.com (1999)). In basic versions of the model, the parties drive the interaction and the mediator just monitors its consistency. Extensions of the model define a more proactive role for e-marketplaces in the orchestration of the parties.

E-marketplaces can be involved in all stages of the lifecycle of an end-to-end transaction. An e-marketplace infrastructure should provide the support services and tools required for the provision of e-services, from their advertising, through their negotiation, to their actual delivery.

However, open e-marketplaces in the Internet push for the dynamic creation of business partnerships with previously unknown companies, with possibly a low level of trust. In fact the trust element deriving from long-term relationship is weakened, and the control measures that companies may have to consider can substantially erode the overall benefits of using e-marketplaces.

### SUMMARY OF THE INVENTION

According to a first aspect of the invention a method of validating a communication between a first participant and a second participant in an electronic interaction, wherein the electronic interaction includes an exchange of information between the first and second participants and includes a request for a service from one of the participants to another participant, the method comprising:

setting at least one interaction policy for the electronic interaction between the first and second participants that is dependent on a state of a stage in the electronic interaction between the first and second parties.

The method advantageously sets at least one policy for the electronic interaction which takes into account the state of an ongoing business process interaction between the first and second participants.

The method preferably includes setting a plurality of interaction policies relevant to different stages of the electronic interaction, preferably to take into account different potential statuses of the electronic interaction.

The method preferably includes setting the or each interaction policy using business process management capabilities in an authorisation server.

The method preferably includes validating the communication between the first and second participants with an authorisation server, preferably the authorisation server incorporates business process management capabilities.

The method may include validating the interaction between the first and second participants using atomic authorisation policies, which are applied independent of a stage or state of the electronic interaction between the first and second parties.

The method of validating a communication between the first and second participants may be carried out by a party independent from the first and second participants. The method may be performed as an independent mediation between the first and second participants.

The method may include validation of communication between more than first and second participants.

The method may include setting interaction policies for a plurality of decision points in the electronic interaction, said decision points may be stages in a business process.

The invention extends to a computer program operable to perform the method of the first aspect, and to a recordable medium bearing a computer program operable to perform said method.

According to a second aspect of the invention an electronic marketplace incorporates a computing platform operable to validate a communication between a first participant and a second participant in an electronic interaction, wherein the electronic interaction includes an exchange of information between the first and second participants and includes a request for a service from one of the participants to the other participant, the computing platform being operable to set at least one interaction policy for the electronic interaction that is dependent on a current state of the electronic interaction.

Said current state of the electronic interaction may be a stage in said exchange of information between the participants.

The computing platform preferably incorporates an authorisation server, which preferably incorporates process management capabilities. The authorisation server preferably includes atomic policy management capabilities, which capabilities are independent of a particular stage in the electronic interaction.

The computing platform is preferably operable to both set and execute authorisation policies. Some of said policies may be independent of the state of the electronic interaction (atomic policies) or may be dependent on the state of the electronic interaction (i.e. process-based policies).

The invention extends to a computing platform as described in relation to the second aspect.

All of the features described herein can be combined with any of the above aspects in any combination.

### BRIEF DESCRIPTION OF THE DRAWINGS

The invention will now be described, by way of example and with reference to the accompanying drawings, in which:

FIG. 1 is a schematic diagram of the interactions between a service provider, an electronic marketplace and a service consumer;

FIG. 2 is a schematic diagram of the architecture of a second generation e-marketplace;

FIG. 3 is a schematic diagram of the architecture of an ESS component of the e-marketplace shown in FIG. 2; and

FIG. 4 is a schematic view of a monitoring interface for the e-marketplace shown in FIG. 2.

### DETAILED DESCRIPTION OF THE PREFERRED EMBODIMENT

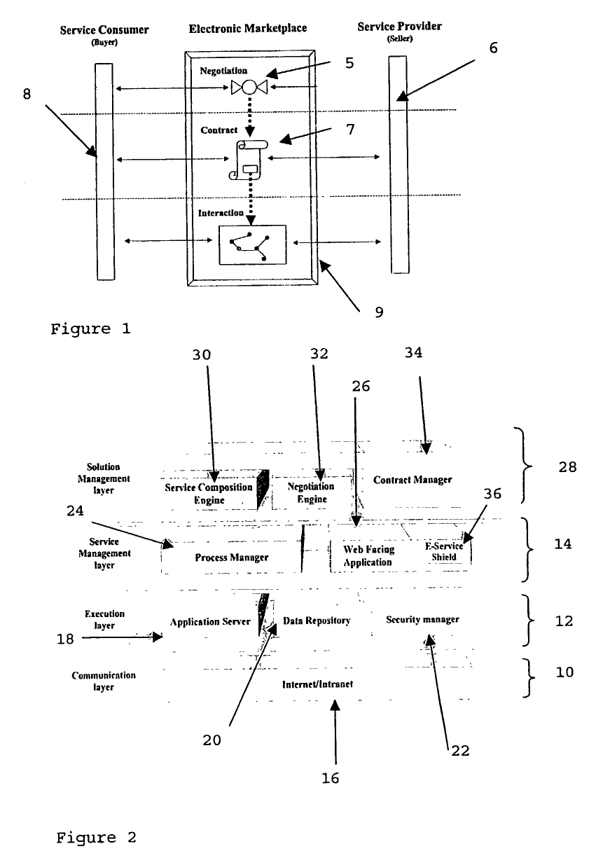

In the context of a second-generation e-marketplace developed by the present applicant, we have designed a model for mediated e-service delivery based on the externalisation of the interaction processes between business parties. In FIG. 1, service providers 6 and service consumers 8 make available this information to an e-marketplace infrastructure 9 through an electronic contract 7, after negotiation 5. The model has driven the design and the implementation of the E-Service Shield (ESS) component, which is responsible for service mediation in the applicant's marketplace infrastructure.

The model and related infrastructure components presented herein permit the e-marketplace to guarantee the behaviours of participants in a business transaction. Let us briefly outline the contribution that e-marketplaces give to a business transaction.

E-service Advertising. The e-marketplace is the virtual place where service offers and requests are stored and made available to the members. Advanced directory services or automatic pattern matching facilities are the main mechanisms provided by e-marketplace infrastructures.

Negotiation. In addition to basic pattern matching between offer and demand, the e-marketplace can provide support for different types of negotiation processes. Beyond the initial contact, the objective is to provide support for all the interaction leading to the formation of a mutually satisfactory contract between the parties, (see for example Griffel, F., Boger M., Weinreich H., Lamersdorf W., Merz M. “Electronic Contracting with COSMOS—How to Establish, Negotiate and Execute Electronic Contracts on the Internet” Proc. 2^{nd} Int. Enterprise Distributed Object Computing Conference (EDOC '98) (1998)). Common market mechanisms involved at this stage are auctions, exchanges, catalogues, and request for quotes. In addition to basic price-related parameters, there are other important issues related to payment procedures, delivery processes, and service level agreement.

Contract Management. The negotiation process produces a contract that captures and formalises the agreement between service consumer and service provider. The rules for the interaction between parties derive from this legally binding agreement. The e-marketplace support to the definition and formalisation of the electronic contract is considered a critical issue. The trustworthiness of the e-marketplace has a strong impact on the level of involvement the parties are willing to accept in terms of mediation, and on the level of control the parties impose to each other.

Service Delivery. Usually neglected by first-generation e-marketplaces, a more direct involvement in the contract execution and service-delivery phase is the focus of second-generation e-marketplaces. Acting as a trusted entity, the e-marketplace can guarantee that both parties involved in the e-service transaction respect the agreed contract. To this purpose, the e-marketplace can exploit a monitoring component to control the interaction, in order to assume a more active role in the business interaction processes.

Accounting. In its role of trusted mediator, an e-marketplace is required to perform several operations also after the actual delivery of the e-service and the conclusion of the contractual relationship between the parties. The information collected about the behaviour of the companies, together with service-level related data, are the basis to prepare the profiles of market members.

Second-generation e-marketplaces, such as the one developed by the applicant, provide infrastructure-level support for all the phases of the business transaction lifecycle. Here we focus on the e-marketplace mediation role in service delivery.

An e-service encapsulates the overall business activity behind the delivery of a product (good or service) to a customer. For example, in the case of the sale of freight space there are specific business processes dealing with the collection of the goods, the exchange of the appropriate paperwork, the flow of notifications between the sender and transport provider, payment procedures, and so on. The e-service model requires to represent the whole interaction process between service provider and consumer in a format automatically tractable. The interaction process can be captured and formalised in the electronic contract, and the parties can map it on their internal processes in order to satisfy their contractual commitments (see FIG. 1). Information about financial history, customer/supplier rating, brand, and other forms of credentials represent an important added value for the negotiation process within e-marketplaces.

In terms of business interaction processes, two main aspects to consider are process flow and data flow. The process flow specifies aspects like the sequence and causal order for the interaction activities between the parties. For instance, in the freight example the process flow may indicate that only after receiving the notification from the customer that goods are ready for collection the transport provider has to collect them. The interaction can evolve along parallel threads and adapt to external requirements. While the goods are travelling the transport provider can be required to inform the customer of potential delays, as well as sending standard progress reports. Depending on the purchased service options the customer may or may not be entitled to ask for certain type of reports, or the reports can be requested only at specific stages of the service. For example, the request for payment is possible only if the invoice has been sent.

Closely interdependent with the process flow, the data flow involved in a business interaction relates to the actual data exchanged in the various steps of the process. The focus is on document types and possibly on the actual content of the documents. The assumption is that the documents are in electronic format, or at least that an electronic description is available. Back to the example, notification messages might need a specific formatting into a format such as ebXML or RosettaNet, (see ebXML, http://www.ebXML.org, RosettaNet, http://www.rosettanet.org). Raising the level of complexity, the amount filed in the invoice has to contain the same value as the pay filed in the bank order.

The e-service model promises to be very powerful in terms of automation of end-to-end transactions, but the implementation of the model requires some considerations. Despite the flourishing of technologic and standardisation activities around e-services and related paradigms, it is not reasonable to expect companies to reconvert their enterprise resource planning and administration systems in the short term. As it has happened for commercial web sites, e-service technology will have to be deployed on top of existing business information systems. An extra layer of protection and service management provided by a trusted e-marketplace can simplify operational models and technical infrastructure required internally by companies.

Companies can clearly benefit from the offloading to a trusted e-marketplace of the interaction processes management, once agreed at contractual level. The initial effort for the definition of the agreement and the reliance on a trusted e-marketplace to enforce it can streamline the internal structure of the company. To this purpose, we propose to extend the mediation role of e-marketplaces to the execution aspects of the e-service delivery contract.

The mediation model described above is embodied in the E-Service Shield (ESS) component (36 in FIG. 2). An integral part of a prototype of second-generation e-marketplace developed by the applicant, ESS is the system component in charge of validating the interaction between service providers and service consumers. In the first part of this section, we give a brief overview of the overall e-marketplace infrastructure. We then concentrate on the internal architecture and implementation of the ESS component.

The main purpose of the e-marketplace developed by the applicant is the investigation of the relations between negotiation, service composition, and electronic contracts. A lot of research has been done in each of these areas individually. The challenge is to integrate existing results into a comprehensive solution. The aim is to sustain entirely new business models. For example, we envisage the possibility for a service provider to acquire dynamically the resources (services) needed for each service instance it sells. Service providers can interact depending on the evolution of the service delivery process, which is in itself an object of negotiation. The business agreement resulting from the negotiation is captured in a format that makes it automatically enforceable, as well as legally binding, such as the WSFL standard, or in the Process Manager product of Hewlett-Packard (HP) (for more information see www.hp.ice.com).

The architecture of the e-marketplace is depicted in FIG. 2. The lower layers (communication 10 and execution 12) provide the standard execution environment for an e-commerce system including internet/intranet communication 16, application server 18, data repository 20 and security manager 22. A service management layer 14 provides advanced access services and process management facilities 24. In particular, it provides a cluster of Web facing services 26 together with functions for membership management (e.g. authentication and profiling) and service-session management. Process management 24 provides the foundation for electronic management of contractual agreements. A solution management layer 28 provides the core facilities for second-generation e-marketplaces, namely service composition 30, negotiation support 32, and contract management 34. The service composition engine 30 defines the requirements for service providers needed to support a specific service request. Requirements are in terms of operational capabilities (e.g. move containers), as well as service delivery processes. The negotiation engine 32 deals with classic auction-based price optimisation, as well as complex contractual issues (namely service delivery process). The contract manager 34 provides monitoring and execution support for electronic contracts. The focus of the contract manager 34 is on the business interaction that derives from contractual agreements.

From an implementation perspective, the prototype has been built by using a wide range of technologies. At one end of the spectrum, we have used off-the-shelf products like HP Process Manager, a BlueStone application server (see www.bluestone.com), and the negotiation engine from a major e-marketplace vendor, in this case MOAI (see www.moai.com). At the other end, we have re-used a number of research prototypes already existing (especially in the area of policy-management), for example ACSIS (see Casassa Mont M., Baldwin A., and Goh C. “POWER Prototype: Towards Integrated Policy-based Management” NOMS-2000, Honolulu, Hawaii (2000)) and developed entirely new components, such as the ESS 36.

The purpose of the ESS component 36 is to support the enforcement of the contractual agreement between companies in terms of interaction processes. The contractual communication flow between service providers 6 and service consumers 8 goes through the e-marketplace 9, which acts as a trusted third party. The first version of ESS 36 is mainly reactive, and focuses on the verification of the communication flow with respect to the stage of the service delivery process at which it occurs. The parties can be confident that incoming requests from their business partners are controlled by ESS 36, and are compliant with the contractual processes they have agreed upon.

The type of interaction policies enforced by ESS 36 is based on a two-layer approach. The idea is that there are two types of conditions that determine the validity of a specific action. Some conditions depend on general characteristics and capabilities of the actors. For example, only the account manager for a company can send an invoice to that company. Some conditions depend on the stage of the interaction process at which the action occurs. For example, an invoice can be sent to the customer only after it has received the goods. These two types of conditions derive from different business policies. They are orthogonal by nature, but their joint use is fundamental to fully capture a business interaction model. On the one hand, we propose that keeping this separation is beneficial for both the design and the enforcement of contractual agreements. On the other hand, we insist on the importance of a service-driven coordination between the two types of policies. The ESS component 36 represents our initial attempt to address these issues.

The approach adopted in ESS is to blend process management with authorisation management, since the use of only one of them becomes extremely complex to deal with in practice. For instance, an authorisation policy can express conditions on the state of a process, but it then needs to be changed for each process. In the previous example, the fact that the invoice can be sent only when the goods have arrived could be modelled as an extension of the policy that allows only the account manager to send it. If the company now agrees with a different customer to send the invoice before the goods, a new policy needs to be created re-stating also the fact that only the account manager can send it. If the company then decides to allow also the sales representative to send the invoice, all the policies may need to be redesigned. Similar problems occur when everything is modelled as a process.

The methodology supported by ESS 36 implies the coexistence of two layers of policies. In the lower layer, atomic authorisation policies deal effectively (and efficiently) with conditions that are independent of the evolution stage of a service instance. In the higher layer, easily customisable processes capture the execution logic of the service. These processes rely upon specific lower level policies depending on the state of execution. A complete example is given in the following section.

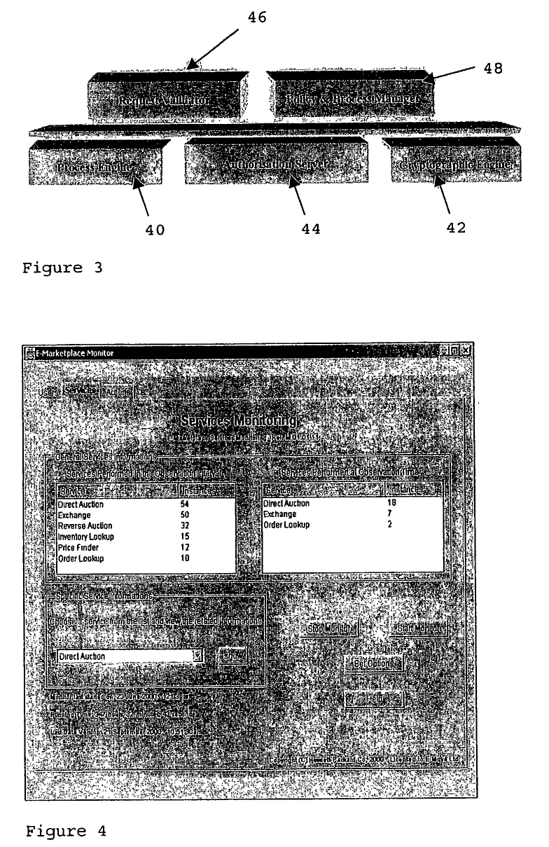

The architecture of the ESS component 36 is based on a foundation layer 38 including a process engine 40, a cryptographic engine 42, and an authorisation server 44 (see FIG. 3). The need for both process management and authorisation management capabilities derives from the type of policies enforced by ESS 36. The cryptographic engine 42 is used for basic validation of the message flow. On top of this basic layer 38, two main components 46, 48 deal with the dynamic validation of the message flow and the management-of the overall system respectively. The request validator 46 verifies that the interaction process specified in the contractual agreement is followed by the parties. When a message is received, the source is verified using standard techniques for digital signatures. The message is then validated against the agreed service delivery process. Finally, the authorisation levels required for the entities involved at the specific stage in the delivery process are verified. Most of the activity for the request validator 46 focuses on the coordination of lower-level components. The policy and process manager component 48 deals with the lifecycle management for the two layers of policies deployed in ESS 36.

Concerning the implementation of the ESS component 36, we have used a number of different technologies. For the process engine, we have used HP Process Manager (referred to above). For the authorisation server we have used ACSIS, (see above) which is a research prototype allowing dynamic reconfiguration for policy specification. We have developed the remaining components on top of the BlueStone Java 2 Enterprise Edition (J2EE) platform and an Oracle database. A view of the monitoring interface for the request validator is presented in FIG. 4.

To describe the impact of the ESS component 36 on business transactions, let us introduce an example in the context of catalogue-based sale of physical goods. The chosen example is from a traditional context, in order to show the impact that ESS 36 would have even on simple e-services.

In the following paragraph there is shown a section of an XML document that describes the specific part of the process with the rules of interaction for catalogue browsing. In particular, when the customer requires an information page, the seller has to provide both the data concerning the product and a sale offer. The customer can then decide to accept the offer, in which case it will have to send both an acceptance notification and a purchase form. However, the customer can decide to decline the offer, but it has to send explicit notification of the fact. The whole procedure has been negotiated in the form of a contract. In this particular case the service “CatalogueBrowsing” was probably offered to the customer at no cost, provided he accepted to comply with the interaction processes proposed by the seller.

<?xml version=“1.0” encoding=“UTF-8”?>
<!DOCTYPE process SYSTEM “interaction.dtd”>
<process name=“CatalogueBrowsing”>

. . .

<sequenceProcess name=“sequence13”>

<action name=“action131” authorisation=“Catalogue-

DetailsSelection” >RequestPage</action>

<parallelProcess name=“parallel132”>

<action name=“action1321”authorisation=“Catalogue-

SendSaleInformation”>Send_Page</action>

<action name=“action1322”authorisation=“Catalogue-

SendSaleInformation”>Send_Offer</action>

</parallelProcess>
<orProcess name=“or133”>
<parallelProcess name=“parallel1331”>

<action name=“action13311”authorisation=“Catalogue

DetailsSelection”>Accept_Offer</action>

<action name=“action13312”authorisation=“Catalogue-

DetailsSelection”>Purchase_Form</action>

</parallelProcess>
<action name=“action1332”authorisation=“Catalogue-

DetailsSelection”>Decline_Offer</action>

</orProcess>

</sequenceProcess>

. . .

</process>

In more detail, the action names (e.g. Send_Offer) in a process node of the interaction process syntax are references to data structures called action cards. An action card contains three types of information related to the specific action: user notification, data type, and content constraints. The user notification is a description of the action itself that is provided to the user in order to understand the other two parts of the information in the node. The content can be a human readable description or some sort of action code for use in automatic systems. This information is added to the business data if the request is valid, and the whole structure is sent to the intended receiver. If the request is not valid, the information on user description is returned to the sender of the message. The information on data type gives indications on how to validate the XML structure of the message. The slot for content constraints can be used to capture conditions to be evaluated on the content of the message itself. The constraint specification language supported by the current version of ESS 36 has been kept very basic, but an extension based on XQL (see http://www.w3.org/TandS/QL/QL98/pp/xql.html) is under development.

The attribute name in the process node contains internal references used by the execution infrastructure. The attribute authorisation is instead the link with service-class policies, and the ACSIS authorisation server. Service-class policies embed service-independent authorisation rules associated to the execution of a process step. In our example, the details of the rule Catalogue-DetailsSelection are presented below.

The first part of the name is an indicator of the library the policy belongs to. The policy itself specifies the constraints that the user has to satisfy. The constraints are defined in terms of the information the authorisation server can gather from different components of the e-marketplace infrastructure. In the example, the authorisation server gathers information from both the connection manager and user profiler. As an aside, the fact that a service-class policy can be reused in different context raises the problem of naming. In the syntax above we can see how the name “DetailsSelection” policy is of no immediate association with action names.

<Service>

<ServiceName>Catalogue</ServiceName>
. . .
<Functions>
<!--. . . . . . .FUNCTION DETAILS_SELECTION. . . . . . . . . .-->

<Function>
<FunctionName>DetailsSelection</FunctionName>

<Conditions>

<!-- WHO can use DetailsSelection -->
<Condition>

<ConditionContent>

<! [CDATA [CONTEXT.hasRole
(“customer”)]]>

</ConditionContent>

</Condition>
<Condition>

<ConditionContent>

<! [CDATA
[CONTEXT.hasAuthenticationLevel (
+TL,19/ “financial-action”) ]]>

</ConditionContent>

</Condition>

</Conditions>

</Function>

. . .
</Functions>

</Service>

The relevance of electronic contracts to e-service provision has triggered a number of initiatives in both academia and industry (see ebXML, http://www.ebXML.org and RosettaNet, http://www.rosettanet.org). Main points of interest regard contract specification, contract lifecycle, and contract execution. Contract specification is usually approached from a very pragmatic angle. Initiatives such as ebXML and RosettaNet adopt a bottom-up approach, and starting from message-oriented ontology they are moving up towards the formalisation of cooperative business processes. In terms of electronic contract lifecycle, the COSMOS platform well exemplifies the type of requirements that management infrastructures have to meet, especially in order to support the contract formation phase (see Griffel, F., Boger M., Weinreich H., Lamersdorf W., Merz M. “Electronic Contracting with COSMOS—How to Establish, Negotiate and Execute Electronic Contracts on the Internet” Proc. 2^{nd} Int. Enterprise Distributed Object Computing Conference (EDOC '98) (1998)). Process management emerges as central, in both the formation and the execution phase of the contract. Focusing on contract execution, Open Flow, Cross Flow, and RABBIT exemplify how different assumptions on the service provisioning model impact on the infrastructure requirements (see Klingemann J, Wäsch J., Aberer K, “Adaptive outsourcing in cross-organisational workflows” In Proceedings of the 11^{th} International Conference on Advanced Information Systems Engineering (CAiSE'99), Heidelberg, Germany (1999), Marton A., Piccinelli G. and Turfin C. “Service provision and composition in virtual business communities”. Proc. 18^{th} IEEE Int. Symposium on Reliable Distributed Systems, Int. Workshop on Electronic Commerce. Lausanne, Switzerland (1999) and Shrivastava S. K., Bellisard L., Feliot D., De Palma N., Wheater S. M. “A workflow and agent based platform for service provisioning” Proc. 4^{th} International Enterprise Distributed Object Computing Conference (EDOC'00) (2000)).

The above-mentioned initiatives present many similar features at different levels (e.g. service model, architectural choices), but the central role played by processes is the main common theme. The need for automatic support to business interaction processes is a key issue for second-generation e-marketplaces.

Trust is both an issue and a source of opportunities for e-marketplaces. The speed of electronic transactions, the broad space of potential business partners, and the potential for price optimisations are just some of the motivations that attract businesses to e-marketplaces. Still, the absence of the proper level of trust between the members of an e-marketplace can dramatically impact on the benefit they can achieve. Trust-related services become crucial components of any e-marketplace infrastructure.

In the scenario of the second-generation e-marketplace developed by the applicant, we propose a simple model for mediated service provision involving the e-marketplace in the role of trusted third party. The model is based on specific views of the business processes underpinning service provision, and active mediation of the communication flow between service providers and service consumers. The electronic contract captures the business interaction processes between the parties, and the ESS infrastructure component 36 enforces the compliance between contractual agreements and the behaviour of the companies. The paper discusses the position of ESS 36 in the applicant's e-marketplace infrastructure, and it describes also the main architectural choices related to the ESS component 36 implementation.

The method and system described advantageously allow the modelling and enforcement of policies that deal with stateful interactions using processes, including business processes, in conjunction with classic authorisation services.

1. A method of validating a communication between a first participant and a second participant in an electronic interaction, wherein the electronic interaction includes an exchange of information between the first and second participants and includes a request for a service from one of the participants to another participant, the method comprising:
setting at least one interaction policy for the electronic interaction between the first and second participants that is dependent on a state of a stage in the electronic interaction between the first and second parties.

2. A method as claimed in claim 1, which includes setting a plurality of interaction policies relevant to different stages of the electronic interaction.

3. A method as claimed in claim 2, in which the interaction policies take into account different potential statuses of the electronic interaction.

4. A method as claimed in claim 1, which includes setting the or each interaction policy using business process management capabilities in an authorisation server.

5. A method as claimed in claim 1, which includes validating the communication between the first and second participants with an authorisation server.

6. A method as claimed in claim 5, in which the authorisation server incorporates business process management capabilities.

7. A method as claimed in claim 1, which is carried out by a party independent from the first and second participants.

8. A method as claimed in claim 7, which is performed as an independent mediation between the first and second participants.

9. A method as claimed in claim 1, which includes the validation of communication between more than first and second participants.

10. A method as claimed in claim 1, which includes setting interaction policies for a plurality of decision points in the electronic interaction.

11. A method as claimed in claim 10, in which said decision points are stages in a business process.

12. A computer program operable to perform the method of claim 1.

13. A recordable medium bearing a computer program operable to perform the method of claim 1.

14. An electronic marketplace incorporates a computing platform operable to validate a communication between a first participant and a second participant in an electronic interaction, wherein the electronic interaction includes an exchange of information between the first and second participants and includes a request for a service from one of the participants to the other participant, the computing platform being operable to set at least one interaction policy for the electronic interaction that is dependent on a current state of the electronic interaction.

15. An electronic marketplace as claimed in claim 14, in which said current state of the electronic interaction is a stage in said exchange of information between the participants.

16. An electronic marketplace as claimed in claim 14, in which the computing platform incorporates an authorisation server.

17. An electronic marketplace as claimed in claim 16, in which the authorisation server incorporates process management capabilities.

18. An electronic marketplace as claimed in claim 14, in which the computing platform is operable to both set and execute authorisation policies.

19. An electronic marketplace as claimed in claim 18, in which some of said policies are independent of the state of the electronic interaction and some of said policies are dependent on the state of the electronic interaction.

20. A computing platform as described in relation to claim 14.
